(19) United States
(12) Patent Application Publication
(10) Pub. No.: US 2023/0213154 A1
(43) Pub. Date: Jul. 6, 2023

(54) Inverted LED filament and LED bulb having same

(71) Applicant: James Lee, Huizhou (CN)

(72) Inventor: James Lee, Huizhou (CN)

(21) Appl. No.: 18/174,661

(22) Filed: Feb. 27, 2023

(51) Int. Cl. F21K 9/238; F21K 9/232

(52) U.S. Cl. CPC F21K 9/238; F21K 9/232; F21Y 2103/10

(57) ABSTRACT

An inverted LED filament includes a circuit board, a plurality of inverted LED light-emitting parts, and pad groups. The inverted LED light-emitting parts are arranged on strip-shaped portions of the circuit board and the pad group is located on the same side end of the strip-shaped portions, when the pad group is connected to a connecting base of an external LED bulb through connection with external pins. The pins can be prevented from blocking light generated by the inverted LED light-emitting parts.

### FIELD OF THE INVENTION

The invention relates to lighting and more particularly to an inverted LED (light-emitting diode) filament and an LED bulb having same.

### BACKGROUND OF THE INVENTION

With the development of lighting technology, traditional incandescent lamps (tungsten filament lamps) are gradually eliminated due to high energy consumption and short service life, and are replaced by LED bulbs. LED bulbs are in a shape similar to that of the traditional incandescent lamps, and adopt the existing traditional screw and socket connection method, which is in line with people's habit of using bulbs.

However, referring to FIG. 1, a conventional LED bulb includes a connecting base 100, an LED filament 110 and pins 120 in the prior art. The LED filament 110 is of a structure with both ends connected, so that when the LED filament 110 is vertically arranged, both ends of the LED filament 110 needs to be electrically connected to the base 100 via the pins 120. In this structure, the pins 120 will cover one side of the LED filament 110. Since the LED filament 110 provides all-around lighting, the pins 120 block the light generated by the LED filament 110 to form a local dark area, which reduces the lighting angle of the LED filament 110 and causes uneven lighting brightness, resulting in affecting the lighting effect.

Thus, the need for improvement still exists.

### SUMMARY OF THE INVENTION

The invention aims at at least solving one of the technical problems existing in the prior art. Therefore, the invention proposes an inverted LED filament and an LED bulb, which can prevent the light generated by the inverted LED light-emitting parts from being blocked by the pins, so that the lighting brightness is uniform and the lighting effect is improved.

An inverted LED filament according to the embodiments of the first aspect of the invention, including: a circuit board, where the circuit board is provided with a conductive layer; a plurality of inverted LED light-emitting parts, where the circuit board is provided with strip-shaped portions, the inverted LED light-emitting parts are arranged on the strip-shaped portions, and the inverted LED light-emitting parts are all electrically connected to the conductive layer; and a pad group, where the pad group is arranged on the circuit board and located on the same side end of the strip-shaped portions, the pad group is electrically connected to the conductive layer, and the pad group can be connected to a connecting base of an external LED bulb.

According to some embodiments of the invention, a first electrode and a second electrode are arranged on the same side wall of the inverted LED light-emitting parts, the conductive layer includes at least two circuit portions, gaps are provided between the circuit portions, and the first electrode and the second electrode are connected to the two different circuit portions respectively.

According to some embodiments of the invention, a fluorescent adhesive layer that is arranged on the circuit board is further included, and the fluorescent adhesive layer surrounds the strip-shaped portions and covers the inverted LED light-emitting parts.

According to some embodiments of the invention, a protection part is further included, the protection part is arranged on the circuit board, and the protection part surrounds the joint between the pad group and the external pins.

According to some embodiments of the invention, the circuit board is made of light-transmitting material.

According to some embodiments of the invention, a rectifying unit that is arranged on the circuit board is further included, the plurality of inverted LED light-emitting parts are connected in series, parallel or series-parallel to form a light-emitting circuit, an input end of the rectifying unit is electrically connected to the pad group via the conductive layer, and an output end of the rectifying unit is electrically connected to the light-emitting circuit via the conductive layer.

According to some embodiments of the invention, the rectifying unit includes a rectifier bridge, an input end of the rectifier bridge is electrically connected to the pad group, and an output end of the rectifier bridge is electrically connected to the light-emitting circuit.

According to some embodiments of the invention, at least two strip-shaped portions are arranged on the circuit board.

An LED bulb according to the embodiments of the second aspect of the invention, including: an inverted LED filament mentioned above, pins, a connecting base, and a light-transmitting cover, where the pad group is connected to the connecting base via the pins, the light-transmitting cover is connected to the connecting base to form a protective cavity for accommodating the inverted LED filament, and the connecting base can be connected to an external lamp holder.

According to some embodiments of the invention, the connecting base is provided with a threaded portion that is connected to the external lamp holder.

Additional aspects and advantages of the invention will be set forth in the description which follows, and in part will become obvious from the description, or may be learned by practice of the invention.

The invention has the following beneficial effects:

By adopting the structure that the inverted LED light-emitting parts are arranged on the strip-shaped portions of the circuit board and the pad group is located on the same side end of the strip-shaped portions, when the pad group is connected to the connecting base of the external LED bulb through connection with external pins, the pins can be prevented from blocking light generated by the inverted LED light-emitting parts, thus the lighting brightness is more uniform, and the lighting effect is improved.

Moreover, the invention further provides an LED bulb. The structure that a protective cavity for accommodating the LED filament is formed by connecting the light-transmitting cover to the connecting base is beneficial to preventing external objects from colliding with the LED filament and prevent damage to the filament. In addition, the pad group of the strip-shaped circuit board can be connected to the connecting base via pins, and the pad group is located on the same side end of the strip-shaped portions, which can prevent light generated by the inverted LED light-emitting parts on the strip-shaped portions from being blocked by the pins, and is conducive to making the lighting brightness more uniform and improving the lighting effect.

The above and other objects, features and advantages of the invention will become apparent from the following detailed description taken with the accompanying drawings

### BRIEF DESCRIPTION OF THE DRAWINGS

FIG. 1 is a schematic side elevation of a conventional LED bulb;

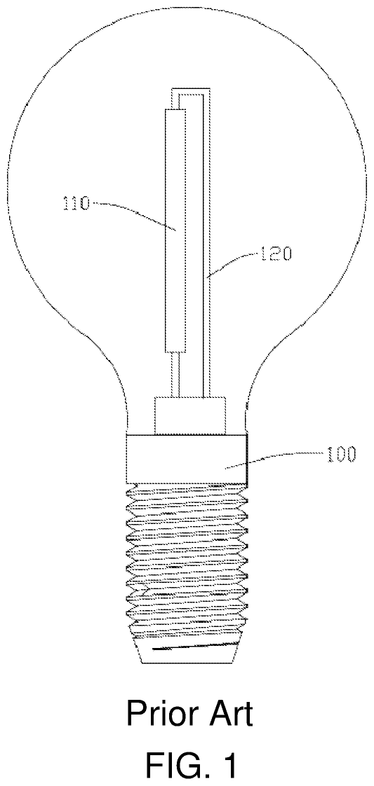

FIG. 2 is a schematic side elevation of an LED bulb incorporating an LED filament according to a first preferred embodiment of the invention;

FIG. 3 is a side elevation of the LED filament of FIG. 2;

FIG. 4 is a longitudinal sectional view of the LED filament of FIG. 3;

FIG. 5 is a detailed view of the area in circle A of FIG. 4;

FIG. 6 is a sectional view of an upper portion of the LED filament of FIG. 4;

FIG. 7 is a longitudinal sectional view of an LED filament according to a second preferred embodiment of the invention;

FIG. 8 is a circuit diagram of the LED filament of FIG. 7; and

FIG. 9 is a longitudinal sectional view of an LED filament according to a third preferred embodiment of the invention.

### DETAILED DESCRIPTION OF THE INVENTION

The following describes in detail the embodiments of the invention, examples of which are illustrated in the accompanying drawings, wherein the same or similar reference numerals refer to the same or similar elements or elements having the same or similar functions throughout. The embodiments described below with reference to the accompanying drawings are exemplary and only used to explain the invention, and should not be construed as a limitation of the invention.

In the description of the invention, it is to be understood that, referring to orientation description, the instructed orientation or positional relationships, for example, upper, lower, front, rear, left, right, etc., are based on the orientation or positional relationships shown in the drawings, merely for ease of description of the invention and simplification for the description, rather than indicating or implying that the device or element referred to must have a specific orientation and be constructed and operated in a specific orientation, which, therefore, cannot be construed as limiting the invention.

In the description of the invention, if described, first and second are only for the purpose of distinguishing technical features, and not to be construed as indicating or implying relative importance or implicitly indicating the number of technical features indicated or implicitly indicating the precedence relationship of technical features indicated.

In the description of the invention, unless explicitly defined otherwise, providing, installing, connecting and other words should be understood broadly, and a person skilled in the art can reasonably determine the specific meaning of the above words in the invention combined with the specific content of the technical solution.

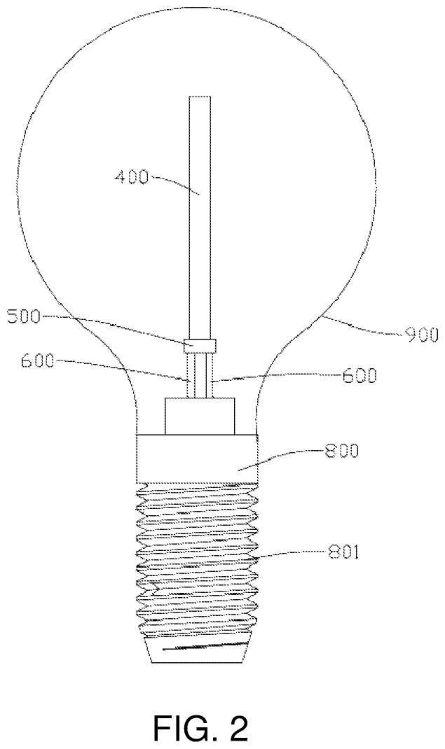

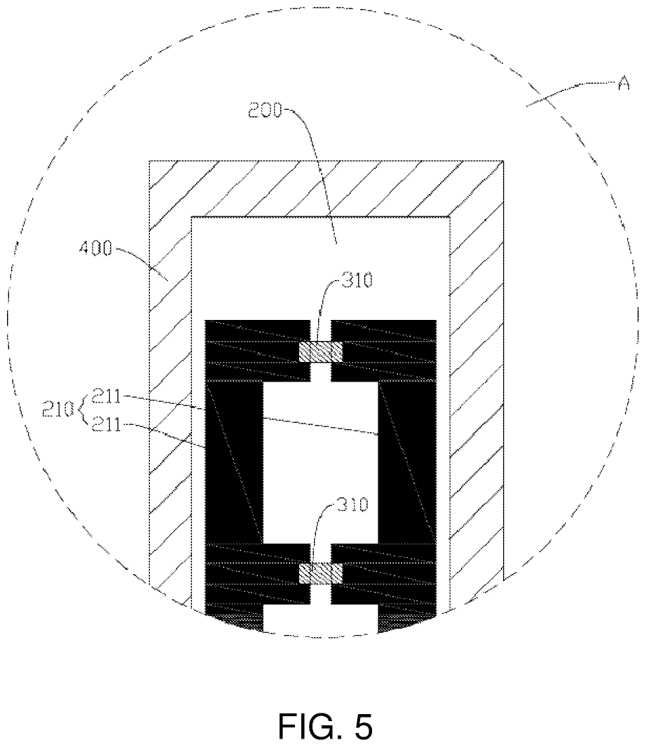

Referring to FIGS. 2-6, an inverted LED filament according to a first preferred embodiment of the invention includes a circuit board 200, where the circuit board 200 is provided with a conductive layer 210; a plurality of inverted LED light-emitting parts 310, where the circuit board 200 is provided with strip-shaped portions 201, the inverted LED light-emitting parts 310 are arranged on the strip-shaped portions 201, and the inverted LED light-emitting parts 310 are all electrically connected to the conductive layer 210; and a pad group 220, where the pad group 220 is arranged on the circuit board 200 and located on the same side end of the strip-shaped portions 201, the pad group 220 is electrically connected to the conductive layer 210, and the pad group 220 can be connected to external pins 600.

By adopting the structure that the inverted LED light-emitting parts 310 are arranged on the strip-shaped portions 201 of the circuit board 200 and the pad group 220 is located on the same side end of the strip-shaped portions 201, when the pad group 220 is connected to a connecting base 800 of an external LED bulb via external pins 600, the pins 600 can be prevented from blocking light generated by the inverted LED light-emitting parts 310, thus the lighting brightness is more uniform, and the lighting effect is improved.

In the first embodiment, the plurality of inverted LED light-emitting parts 310 are connected in parallel to form a light-emitting circuit 300. But it should be noted that the plurality of inverted LED light-emitting parts 310 can also be connected in series-parallel to form the light-emitting circuit 300.

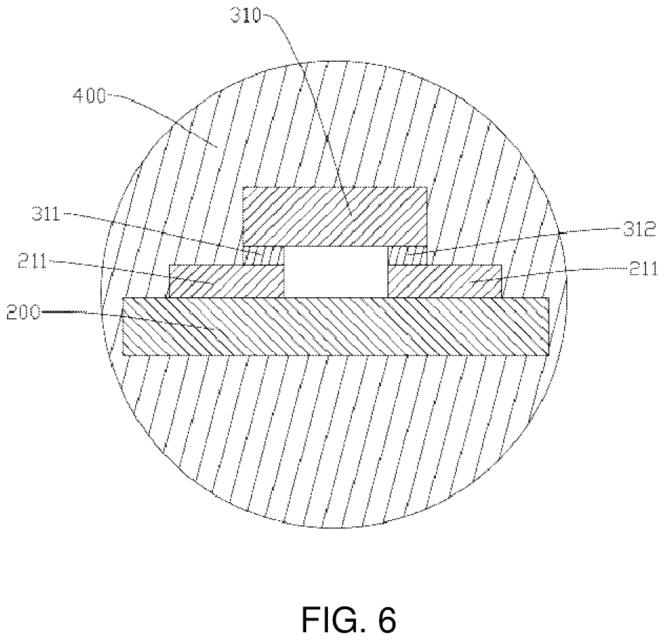

As shown in FIG. 6 specifically, a first electrode 311 and a second electrode 312 are arranged on the same side wall of the inverted LED light-emitting parts 310, the conductive layer 210 includes at least two circuit portions 211, gaps are provided between the circuit portions 211, and the first electrode 311 and the second electrode 312 are connected to the two different circuit portions 211 respectively.

By using inverted LED light-emitting parts 310, such as an inverted LED chip, and other devices, since the first electrode 311 and the second electrode 312 of the inverted LED light-emitting parts 310 are both located on the same side wall, the first electrode 311 and the second electrode 312 can be directly welded to the circuit portions 211 without being connected via wires when the inverted LED light-emitting parts are welded to the conductive layer 210, which can prevent wire breakage and is conducive to improving reliability.

As shown in FIG. 2 specifically, a connecting base 800 is provided with a threaded portion 801 that is connected to an external lamp holder.

The connecting base 800 is threadedly connected to the external lamp holder via the threaded portion 801, which is convenient for disassembly and assembly, is of a simple structure, conforms to the usage habits of traditional bulbs, and makes the use more convenient. The connecting base 800 can also be detachably connected to the external lamp holder by means of a common clamping structure.

As shown in FIGS. 2-6 specifically, a fluorescent adhesive layer 400 that is arranged on the circuit board 200 is further included, and the fluorescent adhesive layer 400 surrounds the strip-shaped portions 201 and covers the inverted LED light-emitting parts 310.

By arranging the fluorescent adhesive layer 400 to cover the inverted LED light-emitting parts 310, the inverted LED light-emitting parts 310 can be protected from damage. Meanwhile, the lighting color can be changed by providing different colors to the fluorescent adhesive layer 400, which is beneficial to meeting the use requirements and improving the lighting effect.

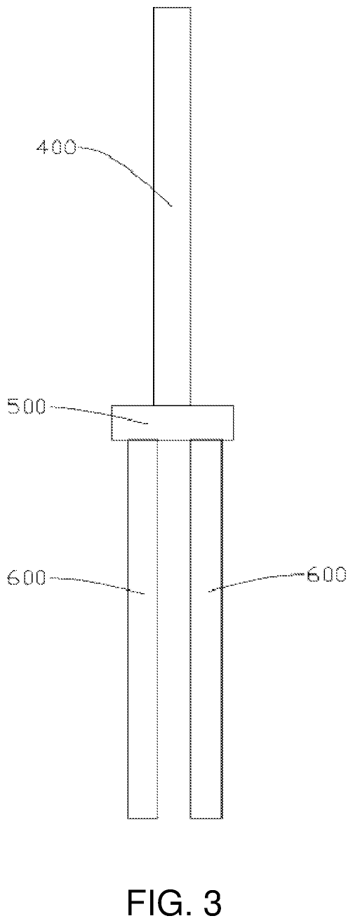

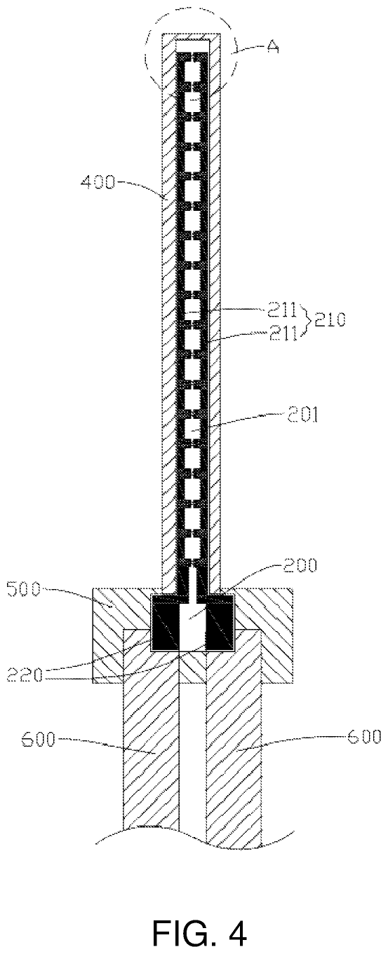

As shown in FIGS. 3-4 specifically, a protection part 500 is further included, the protection part 500 is arranged on the circuit board 200, and the protection part 500 surrounds the joint between the pad group 220 and the external pins 600.

After the pad group 220 is welded to the external pins 600, the protection part 500 is arranged to surround the joint between the pad group 220 and the external pins 60, which is beneficial to protecting the pad group 220, preventing the pad group 220 from being separated from the pins 600, and improving the reliability of the structure.

In the first embodiment, the circuit board 200 is made of light-transmitting material. In this way, the light generated by the inverted LED light-emitting parts 310 can pass through the circuit board 200 and be emitted from the back of the circuit board 200, which is beneficial to realizing the lighting effect of all-round light emission. The light-transmitting material may be a material capable of light transmission such as aluminum oxide ceramics.

As shown in FIG. 2 specifically, an LED bulb according to the first embodiment the present invention includes: the inverted LED filament mentioned above, pins 600, a connecting base 800, and a light-transmitting cover 900, where the pad group 220 is connected to the connecting base 800 via the pins 600, and the light-transmitting cover 900 is connected to the connecting base 800 to form a protective cavity for accommodating the circuit board 200. The structure that the protective cavity for accommodating the LED filament is formed by connecting the light-transmitting cover 900 to the connecting base 800 is beneficial to preventing external objects from colliding with the LED filament and preventing damage to the filament. In addition, the pad group 220 of the strip-shaped circuit board can be connected to the connecting base 800 via the pins 600, and the pad group 220 is located on the same side end of the strip-shaped portions 201, which can prevent light generated by the inverted LED light-emitting parts 310 on the strip-shaped portions 201 from being blocked by the pins 600, and is conducive to making the lighting brightness more uniform and improving the lighting effect.

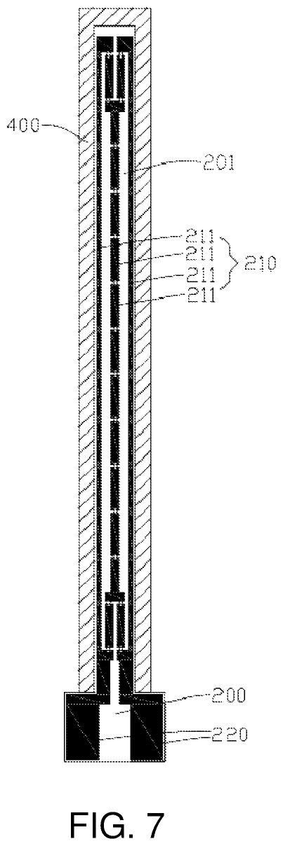

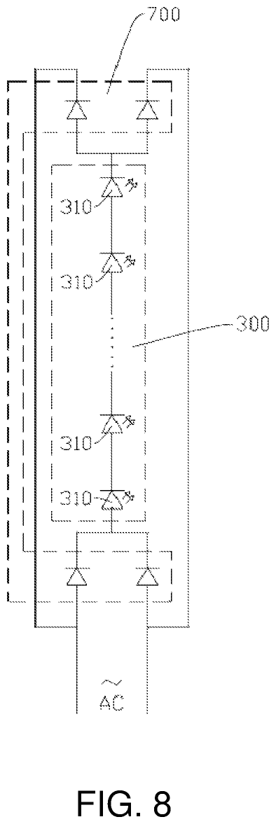

Referring to FIGS. 7-8, an inverted LED filament according to a second preferred embodiment of the invention is shown and its characteristics are detailed below. A rectifying unit 700 arranged on the circuit board 200 is further included. The plurality of inverted LED light-emitting parts 310 are connected in series (see FIG. 7) to form a light-emitting circuit 300, an input end of the rectifying unit 700 is electrically connected to the pad group 220 via the conductive layer 210, and an output end of the rectifying unit 700 is electrically connected to the light-emitting circuit 300 via the conductive layer 210.

Due to the one-way conduction characteristic of the inverted LED light-emitting parts 310, direct current needs to be provided for normal operation. When an external power supply inputs alternating current, the rectifying unit 700 converts the alternating current into direct current and transmits the direct current to the inverted LED light-emitting parts 310 to enable the inverted LED light-emitting parts 310 to work normally, so that the LED filament can be used under the condition of an external power supply inputting alternating current, which satisfies different usage environments.

As shown in FIG. 8 specifically, the rectifying unit 700 includes a rectifier bridge, an input end of the rectifier bridge is electrically connected to the pad group 220, and an output end of the rectifier bridge is electrically connected to the light-emitting circuit 300.

The input alternating current is rectified by the rectifier bridge, which is of a simple structure and is easy to realize. The rectifier bridge can be composed of four ordinary diodes, or can be composed of light-emitting diodes.

The rectifying unit 700 may also be a device or circuit including a switching power supply chip, an AC-to-DC chip, etc. capable of realizing a rectification effect.

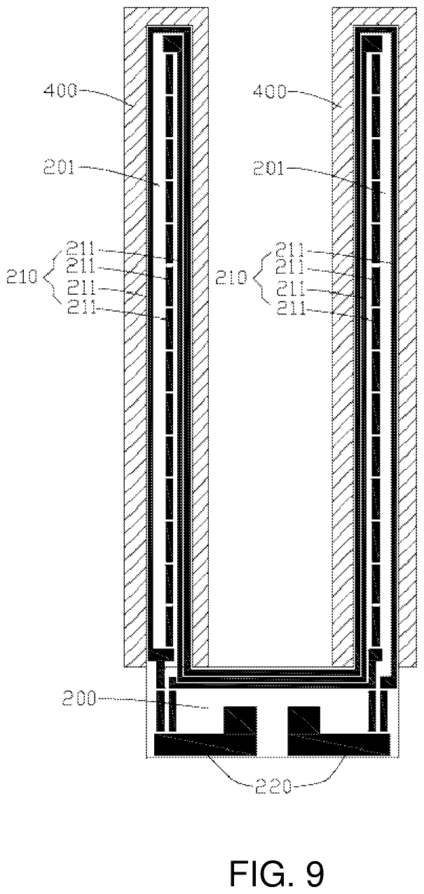

Referring to FIG. 9, an inverted LED filament according to a third preferred embodiment of the invention is shown and its characteristics are detailed below. At least two strip-shaped portions 201 are provided on the circuit board 200.

While the invention has been described in terms of preferred embodiments, those skilled in the art will recognize that the invention can be practiced with modifications within the spirit and scope of the appended claims.

What is claimed is:

1. An inverted LED filament, comprising:
a circuit board, wherein the circuit board is provided with a conductive layer;
a plurality of inverted LED light-emitting parts, wherein the circuit board is provided with strip-shaped portions, the inverted LED light-emitting parts are arranged on the strip-shaped portions, and the inverted LED light-emitting parts are all electrically connected to the conductive layer; and
a pad group, wherein the pad group is arranged on the circuit board and located on the same side end of the strip-shaped portions, the pad group is electrically connected to the conductive layer, and the pad group can be connected to external pins.

2. The inverted LED filament of claim 1, wherein a first electrode and a second electrode are arranged on the same side wall of the inverted LED light-emitting parts, the conductive layer comprises at least two circuit portions, gaps are provided between the circuit portions, and the first electrode and the second electrode are connected to the two different circuit portions respectively.

3. The inverted LED filament of claim 1, further comprising a fluorescent adhesive layer that is arranged on the circuit board, and the fluorescent adhesive layer surrounds the strip-shaped portions and covers the inverted LED light-emitting parts.

4. The inverted LED filament of claim 1, further comprising a protection part, wherein the protection part is arranged on the circuit board, and the protection part surrounds the joint between the pad group and the external pins.

5. The inverted LED filament of claim 1, wherein the circuit board is made of light-transmitting material.

6. The inverted LED filament of claim 1, further comprising a rectifying unit that is arranged on the circuit board, wherein the plurality of inverted LED light-emitting parts are connected in series, parallel or series-parallel to form a light-emitting circuit, an input end of the rectifying unit is electrically connected to the pad group via the conductive layer, and an output end of the rectifying unit is electrically connected to the light-emitting circuit via the conductive layer.

7. The inverted LED filament of claim 6, wherein the rectifying unit comprises a rectifier bridge, an input end of the rectifier bridge is electrically connected to the pad group, and an output end of the rectifier bridge is electrically connected to the light-emitting circuit.

8. The inverted LED filament of claim 1, wherein at least two strip-shaped portions are arranged on the circuit board.
